(19) United States
(12) Patent Application Publication
(10) Pub. No.: US 2024/0279932 A1
(43) Pub. Date: Aug. 22, 2024

(54) SELF-ADHERING ROOFING MEMBRANE

(71) Applicant: Garland Industries, Inc., Independence, OH (US)

(72) Inventors: Joel Shealey, Independence, OH (US); Marivic Smith, Independence, OH (US); David Allen, Independence, OH (US); Harold Myers, Independence, OH (US)

(21) Appl. No.: 18/438,803

(22) Filed: Feb. 12, 2024

Related U.S. Application Data
(60) Provisional application No. 63/446,139, filed on Feb. 16, 2023.

(51) Int. Cl. E04D 5/14; C08L 95/00; E04D 5/02

(52) U.S. Cl. CPC E04D 5/148; C08L 95/00; E04D 5/02; C08L 2555/86

(57) ABSTRACT

A self-adhering reinforced APP (atactic polypropylene) bitumen roofing membrane or APP and IPP (Isotactic Polypropylene) bitumen roofing membrane. The reinforced bitumen roofing membrane includes 1) a bitumen compound layer that includes APP, 2) a fiber reinforcement layer, 3) an optional release liner that is releasably positioned on the bottom surface of the bitumen roofing membrane, and/or 4) an optional release film that is releasably positioned on the top surface of the fiber reinforcement layer or bitumen compound layer.

The present application claims priority to U.S. Provisional Application Ser. No. 63/446,139 filed Feb. 16, 2023, which is incorporated herein by reference.

### FIELD OF DISCLOSURE

The present disclosure is directed to an improved roofing membrane system;
particularly the present disclosure is directed to a reinforced bitumen roofing membrane; more particularly the present disclosure is directed to a self-adhering reinforced APP bitumen roofing membrane or an APP and IPP bitumen roofing membrane.

### BACKGROUND OF THE INVENTION

Self-adhering roof membranes have been common in the roofing industry for many years. These self-adhering roof membranes include a bitumen layer that has been modified SBS as the modifier. Prior art patents that disclose such roofing membrane are disclosed in U.S. Pat. Nos. 7,803,725; 6,502,360; 6,296,921; 6,296,912; 5,695,373; 5,643,399; 5,540,971; 5,474,838; 5,456,785; 4,342,804; and 4,039,706, which are all fully incorporated herein.

Some self-adhering roof membranes have been formed wherein there is one layer of SBS (styrene-butadiene-styrene) modified bitumen and a second layer of APP (atactic polypropylene) modified bitumen, wherein the layer of APP bitumen is placed on the top side of the roofing membrane and the layer of SBS modified bitumen is placed on the bottom of the roofing membrane to form a hybrid self-adhering roofing membrane.

Currently APP modified bitumen roofing membranes are predominantly installed by heating the APP modified bitumen roofing membrane with a propane torch to enable the APP modified bitumen roofing membrane to bond to either the roof substrate or another APP modified bitumen roofing membrane. The applied is used since prior art APP modified bitumen roofing membranes are not self-adhering. The side and end laps of the APP modified bitumen roofing membrane were also heated to create a monolithic membrane on the roof of a structure.

Unfortunately, open flames from use of the propane torch can result in numerous safety hazards such as fire to the roof structure and/or building, and damage to the roofing membrane. Insurance companies have begun to severely limit or restrict a contractor's ability to work with roofing membrane that require torching for installation. As such, APP modified bitumen roofing membrane for installation on roof systems are becoming less common.

Cold adhesive systems have been used with limited success with APP membranes due to the cold adhesive systems containing high levels of VOC's and the softening of the APP modified bitumen roofing membrane that occurs when the VOC's migrate into the APP modified bitumen roofing membrane. Also, these cold adhesive systems typically contain SBS, which is typically incompatible and do not properly bond with APP modified bitumen roofing membranes.

APP modified bitumen roofing membranes have been found to be more UV resistant than SBS modified bitumen roofing membranes and have proven to have longer life expectancies than SBS modified bitumen roofing membranes. However, the declining use of APP modified bitumen roofing membranes due there limited applications without the use of heat installation has reduced their use in the industry. As such, there is a need for a self-adhering reinforced APP or APP and IPP bitumen roofing membrane.

### SUMMARY OF DISCLOSURE

The present disclosure is directed to an improved roofing membrane system; particularly the present disclosure is directed to a reinforced bitumen roofing membrane; more particularly the present disclosure is directed to a self-adhering reinforced APP (atactic polypropylene) bitumen roofing membrane or APP and IPP (Isotactic Polypropylene [e.g., Isotactic PolyPropylene Homopolymer]) bitumen roofing membrane. In one non-limiting embodiment, the reinforced bitumen roofing membrane includes less than 1 wt. % SBS (styrene-butadiene-styrene) (e.g., 0-0.999 wt. % and all values and ranges therebetween), and typically less than 0.1 wt. % SBS, and more particularly less than 0.01 wt. % SBS.

In one non-limiting aspect of the present disclosure, the reinforced bitumen roofing membrane includes 1) a bitumen compound layer that includes APP, 2) a fiber reinforcement layer, 3) an optional release liner that is releasably positioned on the bottom surface of the bitumen roofing membrane, and/or 4) an optional release film that is releasably positioned on the top surface of the fiber reinforcement layer or bitumen compound layer.

In another non-limiting aspect of the present disclosure, there is provided a self-adhering APP membrane that provides a more UV resistant than prior art SBS self-adhering membranes. The self-adhering APP membrane in accordance with the present disclosure does not require an open flame to install the APP membrane, thus eliminating the risk of fires when installing the APP membrane.

### The Bitumen Compound Layer

The bitumen compound layer includes a) primary hydrocarbon compound (e.g., bitumen or asphalt, coal tar); b) primary polymer modifier that includes APP [Atactic Polypropylene]; and c) resin material (e.g., C4-C9 resin material; cis/trans 1,3-pentadienes, 2-methyl-2-butene, cyclopentene, cyclopentadiene, dicyclopentadiene, polyisobutene, cycloalphaliphatic hydrocarbon resin, aliphatic C-5 to C-9 hydrocarbon resin, aromatically modified C-5 to C-9 hydrocarbon resin, etc.).

In another non-limiting aspect of the present disclosure, the bitumen compound layer can include one or more optional additives such as 1) filler (e.g., calcium carbonate, chalk, clay, dolomite, kaolin, silica, talc, etc.); 2) IPP [Isotactic Polypropylene]; 3) secondary polymer modifier (e.g., APAO [Amorphous Polyolefin], EVA [Ethylene Vinyl Acetate], EBA [Ethylene Butyl Acrylate], PPA [Polyphthalamide], PPI [Polymeric Polyisocyanate], PE [Polyethylene], PP [Polypropylene] that is different from the APP and IPP, SEBS [Styrene Ethylene Butadiene Styrene], SBS [Styrene Butadiene Styrene], SIS [Styrene-Isoprene-Styrene], thermoplastic urethane [TPU], etc.); 4) process oil (e.g., naphthenic oil, paraffinic oil, etc.); 5) tackifying agent; 6) antioxidant; 7) UV stabilizer; 8) cross-linkers; 9) biocide; 10) coloring agent; 11) metal flakes; 12) adhesion enhancer; 13) fire retardant (e.g., alumina trihydrate, ammonium polyphosphate, etc.); 14) softening agent; 15) wax (e.g., paraffin wax, etc.); 16) acid (e.g., stearic acid, etc.); and/or 17) reinforcement fibers (e.g., Kevlar®, carbon fibers, fiberglass, boron fibers, etc.).

In another non-limiting aspect of the present disclosure, the primary hydrocarbon compound constitutes 25-90 wt. % (and all values and ranges therebetween) of the bitumen compound layer. In one specific formulation, the primary hydrocarbon compound constitutes 30-80 wt. % of the bitumen compound layer. In another specific formulation, the primary hydrocarbon compound constitutes 35-70 wt. % of the bitumen compound layer. In another specific formulation, the primary hydrocarbon compound constitutes 35-60 wt. % of the bitumen compound layer. In another specific formulation, the primary hydrocarbon compound constitutes 40-55 wt. % of the bitumen compound layer. The primary hydrocarbon compound can be fully formed of bitumen, or can be a mixture of bitumen and coal tar. The type of bitumen used in the bitumen compound layer is non-limiting. In one non-limiting example, the bitumen is 125-225 Pen asphalt (and all values and ranges therebetween). Another non-limiting example is that the bitumen is 185 Pen asphalt.

In another non-limiting aspect of the present disclosure, the APP [Atactic Polypropylene] constitutes 1-30 wt. % (and all values and ranges therebetween) of the bitumen compound layer. In another specific formulation, the APP constitutes 1-20 wt. % of the bitumen compound layer. In another specific formulation, the APP constitutes 2-25 wt. % of the bitumen compound layer. In another specific formulation, the APP constitutes 5-20 wt. % of the bitumen compound layer. In another specific formulation, the APP constitutes 8-15 wt. % of the bitumen compound layer.

In another non-limiting aspect of the present disclosure, the resin material (e.g., C4 resin material to C9 resin material) constitutes 1-25 wt. % (and all values and ranges therebetween) of the bitumen compound layer. In another specific formulation, the resin material constitutes 2-20 wt. % of the bitumen compound layer. In another specific formulation, the resin material constitutes 4-15 wt. % of the bitumen compound layer. In another specific formulation, the resin material constitutes 5-10 wt. % of the bitumen compound layer. In another non-limiting embodiment, the weight ratio of APP to resin material in the bitumen compound layer is 0.1:1 to 10:1 (and all values and ranges therebetween). In another non-limiting embodiment, the weight ratio of APP to resin material in the bitumen compound layer is 0.5:1 to 8:1. In one non-limiting formulation, the weight ratio of APP to resin material in the bitumen compound layer is 0.8:1 to 6:1. In another non-limiting formulation, the weight ratio of APP to resin material in the bitumen compound layer is 1:1 to 4:1. In another non-limiting formulation, the weight ratio of APP to resin material in the bitumen compound layer is 1.05:1 to 2:1. In one non-limiting embodiment, the weight percent of APP in the bitumen compound layer is greater than that weight percent of resin material in the bitumen compound layer. In another non-limiting embodiment, the weight ratio of resin material to IPP (when used) in the bitumen compound layer is 0.02:1 to 7.5:1 (and all values and ranges therebetween). In another non-limiting embodiment, the weight ratio of resin material to IPP (when used) in the bitumen compound layer is 0.5:1 to 7:1. In one non-limiting formulation, the weight ratio of resin material to IPP (when used) in the bitumen compound layer is 0.8:1 to 5:1. In another non-limiting formulation, the weight ratio of resin material to IPP (when used) in the bitumen compound layer is 1:1 to 4:1. In another non-limiting formulation, the weight ratio of resin material to IPP (when used) in the bitumen compound layer is 1.01:1 to 2:1. In one non-limiting embodiment, the weight percent of resin material in the bitumen compound layer is less than the weight percent of APP in the bitumen compound layer. In another non-limiting embodiment, the weight percent of resin material in the bitumen compound layer is less than a) the weight percent of primary hydrocarbon compound in the bitumen compound layer, and b) the weight percent of APP in the bitumen compound layer. In another non-limiting embodiment, the weight percent of resin material in the bitumen compound layer is less than a) the weight percent of primary hydrocarbon compound in the bitumen compound layer, b) the weight percent of APP in the bitumen compound layer, and c) the weight percent of filler, when used. In another non-limiting embodiment, the weight percent of resin material in the bitumen compound layer is less than a) the weight percent of primary hydrocarbon compound in the bitumen compound layer, b) the weight percent of APP in the bitumen compound layer, and c) the weight percent of filler, when used; and the weight percent of resin material in the bitumen compound layer is greater than any other additive in the bitumen compound layer. In another non-limiting embodiment, the resin material can include one or more of a) Wingtack 102 [Aliphatic C-5 Hydrocarbon Resin], b) Wingtack 86 [Aromatically modified C-5 Hydrocarbon Resin—Benzene, (1-methylethenyl)-, polymer with 2-methyl-2-butene and 1,3 pentadiene], c) RWTZ7850 [Aliphatic C-5 Hydrocarbon Resin], d) Wingtack STS [Aromatically modified C-5 Petroleum Hydrocarbon Resin], e) Hikotak P-110S [Petroleum Hydrocarbon Resin], f) Nevchem 300 [Petroleum Hydrocarbon Resin], g) Super Nevtac 90 [Petroleum Hydrocarbon Resin C-5], h) Escorez 5340 [Cycloaliphatic hydrocarbon Resin], and/or i) Oppanol [Polyisobutene]. In another non-limiting embodiment, the resin material is a C5 resin.

In another non-limiting aspect of the present disclosure, the filler, when included in the bitumen compound layer, constitutes about 0.5-66 wt. % (and all values and ranges therebetween) of the bitumen compound layer. In one non-limiting formulation, the filler (when used) constitutes 1-50 wt. % of the bitumen compound layer. In another non-limiting formulation, the filler (when used) constitutes 10-45 wt. % of the bitumen compound layer. In another non-limiting formulation, the filler (when used) constitutes 15-40 wt. % of the bitumen compound layer. In another non-limiting formulation, the filler (when used) constitutes 20-35 wt. % of the bitumen compound layer. In another non-limiting embodiment, the weight percent of filler in the bitumen compound layer (when used) is less than a) the weight percent of primary hydrocarbon compound in the bitumen compound layer. In another non-limiting embodiment, the weight percent of filler in the bitumen compound layer (when used) is greater than a) the weight percent of APP in the bitumen compound layer, and b) the weight percent of the resin material. The filler can include one or more of calcium carbonate, chalk, clay, dolomite, kaolin, silica, talc, etc.; however, other or additional filler can be used. In one non-limiting formulation, the filler (when used) includes calcium carbonate, silica and/or talc. In another non-limiting formulation, the filler, when used, includes calcium carbonate.

In another non-limiting aspect of the present disclosure, the IPP [Isotactic Polypropylene], when included in the bitumen compound layer, constitutes about 0.01-20 wt. % (and all values and ranges therebetween) of the bitumen compound layer. In one specific formulation, the IPP (when used) constitutes 0.5-12 wt. % of the bitumen compound layer. In another specific formulation, the IPP (when used) constitutes 1-10 wt. % of the bitumen compound layer. In another specific formulation, the IPP (when used) constitutes 2-8 wt. % of the bitumen compound layer. In another specific formulation, the IPP (when used) constitutes 2.5-10 wt. % of the bitumen compound layer. In another non-limiting embodiment, the weight ratio of APP to IPP in the bitumen compound layer, when IPP is used, is 1:1 to 300:1 (and all values and ranges therebetween). In another non-limiting embodiment, the weight ratio of APP to IPP in the bitumen compound layer, when IPP is used, is 1:1 to 10:1. In one non-limiting formulation, the weight ratio of APP to IPP in the bitumen compound layer, when IPP is used, is 1.2:1 to 5:1. In another non-limiting formulation, the weight ratio of APP to IPP in the bitumen compound layer, when IPP is used, is 1.3:1 to 3.5:1. In another non-limiting embodiment, the weight percent of the IPP (when used) in the bitumen compound layer is less than a) the weight percent of primary hydrocarbon compound in the bitumen compound layer, and b) the weight percent of the APP in the bitumen compound layer. In another non-limiting embodiment, the weight percent of the IPP (when used) in the bitumen compound layer (when used) is less than a) the weight percent of primary hydrocarbon compound in the bitumen compound layer, b) the weight percent of the APP in the bitumen compound layer, and c) the weight percent of the filler (when used) in the bitumen compound layer. In another non-limiting embodiment, the weight percent of the IPP (when used) in the bitumen compound layer is less than a) the weight percent of primary hydrocarbon compound in the bitumen compound layer, b) the weight percent of the APP in the bitumen compound layer, c) the weight percent of the filler (when used) in the bitumen compound layer, and d) the weight percent of the resin material in the bitumen compound layer.

In another non-limiting aspect of the present disclosure, the secondary polymer modifier, when included in the bitumen compound layer, constitutes about 0.01-20 wt. % (and all values and ranges therebetween) of the bitumen compound layer. In one specific formulation, the secondary polymer modifier (when used) constitutes 0.5-12 wt. % of the bitumen compound layer. In another specific formulation, the secondary polymer modifier (when used) constitutes 1-10 wt. % of the bitumen compound layer. In another specific formulation, the secondary polymer modifier (when used) constitutes 1.5-8 wt. % of the bitumen compound layer. In another specific formulation, the secondary polymer modifier (when used) constitutes 2-8 wt. % of the bitumen compound layer. In another non-limiting embodiment, the weight percent of the secondary polymer (when used) in the bitumen compound layer is less than a) the weight percent of primary hydrocarbon compound in the bitumen compound layer, and b) the weight percent of the APP in the bitumen compound layer. In another non-limiting embodiment, the weight percent of the secondary polymer (when used) in the bitumen compound layer (when used) is less than a) the weight percent of primary hydrocarbon compound in the bitumen compound layer, b) the weight percent of the APP in the bitumen compound layer, and c) the weight percent of the filler (when used) in the bitumen compound layer. In another non-limiting embodiment, the weight percent of the secondary polymer (when used) in the bitumen compound layer is less than a) the weight percent of primary hydrocarbon compound in the bitumen compound layer, b) the weight percent of the APP in the bitumen compound layer, c) the weight percent of the filler (when used) in the bitumen compound layer, and d) the weight percent of the resin material in the bitumen compound layer. In another non-limiting embodiment, the weight percent of the secondary polymer (when used) in the bitumen compound layer is less than a) the weight percent of primary hydrocarbon compound in the bitumen compound layer, b) the weight percent of the APP in the bitumen compound layer, c) the weight percent of the filler (when used) in the bitumen compound layer, d) the weight percent of the resin material in the bitumen compound layer, and e) the weight percent of IPP (when used) in the bitumen compound layer. The secondary polymer modifier (when used) can include one or more of APAO (Amorphous Polyolefin), APP (Atactic Polypropylene), EVA (Ethylene Vinyl Acetate), EBA (Ethylene Butyl Acrylate), PPA (Polyphthalamide), PPI (Polymeric Polyisocyanate), PE (Polyethylene), PP/PE copolymer (e.g., TCCK™, etc.), SEBS (Styrene Ethylene Butadiene Styrene), SBS (Styrene Butadiene Styrene), SIS (Styrene-Isoprene-Styrene), SBR (styrene-butadiene-rubber), thermoplastic urethane (TPU), etc.; however, other or additional polymer modifier can be used. In one non-limiting formulation, the polymer modifier includes SBS and/or polyurethane. In another non-limiting formulation, the polymer modifier includes SBS.

In another non-limiting aspect of the present disclosure, the process oil, when included in the bitumen compound layer, is about 0.01-20 wt. % (and all values and ranges therebetween) of the bitumen compound layer. In one non-limiting formulation, the process oil (when used) constitutes 0.05-15 wt. % of the bitumen compound layer. In another non-limiting formulation, the process oil (when used) constitutes 0.1-10 wt. % of the bitumen compound layer. In another non-limiting formulation, the process oil (when used) constitutes 0.5-5 wt. % of the bitumen compound layer. In another non-limiting formulation, the weight percent of process oil (when used) in the bitumen compound layer is less than a) the weight percent of the primary hydrocarbon compound in the bitumen compound layer, and b) the weight percent of filler (when used) in the bitumen compound. In another non-limiting formulation, the weight percent of process oil (when used) in the bitumen compound layer is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. The process oil can include one or more of naphthenic oil, paraffinic oil, etc.

In another non-limiting aspect of the present disclosure, the antioxidant, when included in the bitumen compound layer, is about 0.01-15 wt. % (and all values and ranges therebetween) of the bitumen compound layer. In one non-limiting formulation, the antioxidant (when used) constitutes 0.01-5 wt. % of the bitumen compound layer. In another non-limiting formulation, the antioxidant (when used) constitutes 0.05-2 wt. % of the bitumen compound layer. In another non-limiting formulation, the weight percent of antioxidant in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the antioxidant can include one or more of aromatic amines, hindered phenolics, phosphites, sulfur-containing compounds (e.g., thioethers, thioesters, etc.); however, other or additional antioxidant can be used.

In another non-limiting aspect of the present disclosure, the UV stabilizer, when included in the bitumen compound layer, is about 0.01-15 wt. % (and all values and ranges therebetween) of the (when used), when used, constitutes 0.01-5 wt. % of the bitumen compound layer. In another non-limiting formulation, the UV stabilizer (when used) constitutes 0.05-2 wt. % of the bitumen compound layer. In another non-limiting formulation, the weight percent of UV stabilizer in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the UV stabilizer can include one or more of benzotriazole UV absorber, hindered amine radical scavenge (e.g., Light Stabilizer 770, etc.), layered double hydroxide (LDH), carbon black, etc.; however, other or additional UV stabilizer can be used.

In another non-limiting aspect of the present disclosure, the cross-linkers, when included in the bitumen compound layer, are about 0.01-15 wt. % (and all values and ranges therebetween) of the bitumen compound layer. In one non-limiting formulation, the cross-linkers (when used) constitute 0.01-10 wt. % of the bitumen compound layer. In another non-limiting formulation, the cross-linkers (when used) constitute 0.05-5 wt. % of the bitumen compound layer. In another non-limiting formulation, the weight percent of cross-linkers in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the cross-linkers can include one or more of sulfur, sulfur compounds, bismaleimides, polymerizable monofunctional vinyl aromatic monomer (e.g., styrene, etc.), polyfunctional polymerizable vinyl aromatic monomer (e.g., divinylbenzene, etc.), etc.; however, other or additional cross-linkers can be used.

In another non-limiting aspect of the present disclosure, the biocide, when included in the bitumen compound layer, is about 0.01-10 wt. % (and all values and ranges therebetween) of the bitumen compound layer. In one non-limiting formulation, the biocide (when used) constitutes 0.01-5 wt. % of the bitumen compound layer. In another non-limiting formulation, the biocide (when used) constitutes 0.05-1 wt. % of the bitumen compound layer. In another non-limiting formulation, the weight percent of biocide in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the biocide can include one or more of copper sulfate, zinc chloride, quaternary ammonium-based biocides, aldehydes, hydroxy compounds, o-phthalaldehyde, etc.; however, other or additional biocide can be used.

In another non-limiting aspect of the present disclosure, the coloring agent, when included in the bitumen compound layer, is about 0.01-10 wt. % (and all values and ranges therebetween) of the bitumen compound layer. In one non-limiting formulation, the coloring agent (when used) constitutes 0.01-5 wt. % of the bitumen compound layer. In another non-limiting formulation, the coloring agent (when used) constitutes 0.05-4 wt. % of the bitumen compound layer. In another non-limiting formulation, the weight percent of coloring agent in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer.

In another non-limiting aspect of the present disclosure, the metal flakes, when included in the bitumen compound layer, are about 0.01-15 wt. % (and all values and ranges therebetween) of the bitumen compound layer. In one non-limiting formulation, the metal flakes (when used) constitute 0.01-5 wt. % of the bitumen compound layer. In another non-limiting formulation, the metal flakes (when used) constitute 0.05-2 wt. % of the bitumen compound layer. In another non-limiting formulation, the weight percent of metal flakes in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer.

In another non-limiting aspect of the present disclosure, the adhesion enhancer, when included in the bitumen compound layer, is about 0.01-10 wt. % (and all values and ranges therebetween) of the bitumen compound layer. In one non-limiting formulation, the adhesion enhancer (when used) constitutes 0.01-5 wt. % of the bitumen compound layer. In another non-limiting formulation, the adhesion enhancer (when used) constitutes 0.05-2 wt. % of the bitumen compound layer. In another non-limiting formulation, the weight percent of adhesion enhancer in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the adhesion enhancer can include one or more of amine adhesion promoters, naphthenates, organosilanes-based adhesion promoters, etc.; however, other or additional adhesion enhancer can be used.

In another non-limiting aspect of the present disclosure, the fire retardant, when included in the bitumen compound layer, is about 0.01-20 wt. % (and all values and ranges therebetween) of the bitumen compound layer. In one non-limiting formulation, the fire retardant (when used) constitutes 0.05-15 wt. % of the bitumen compound layer. In another non-limiting formulation, the fire retardant (when used) constitutes 0.05-12 wt. % of the bitumen compound layer. In another non-limiting formulation, the fire retardant (when used) constitutes 0.05-10 wt. % of the bitumen compound layer. In another non-limiting formulation, the weight percent of fire retardant in the bitumen compound layer (when used) is less than a) the weight percent of the primary hydrocarbon compound in the bitumen compound layer, and b) the weight percent of filler (when used) in the bitumen compound. In one non-limiting formulation, the fire retardant can include one or more of alumina trihydrate, ammonium polyphosphate, magnesium hydroxide, melamine, etc.; however, other or additional fire retardant can be used.

In another non-limiting aspect of the present disclosure, the tackifying agent, when included in the bitumen compound layer, is about 0.01-15 wt. % (and all values and ranges therebetween) of the bitumen compound layer. In one non-limiting formulation, the tackifying agent (when used) constitutes 0.01-5 wt. % of the bitumen compound layer. In another non-limiting formulation, the tackifying agent (when used) constitutes 0.05-2 wt. % of the bitumen compound layer. In another non-limiting formulation, the weight percent of tackifying agent in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the tackifying agent can include one or more of inorganic salt electrolytes and organic tackifiers, etc.; however, other or additional tackifying agent can be used.

In another non-limiting aspect of the present disclosure, the softening agent, when included in the bitumen compound layer, is about 0.01-15 wt. % (and all values and ranges therebetween) of the bitumen compound layer. In one non-limiting formulation, the softening agent (when used) constitutes 0.01-5 wt. % of the bitumen compound layer. In another non-limiting formulation, the softening agent (when used) constitutes 0.05-2 wt. % of the bitumen compound layer. In another non-limiting formulation, the weight percent of softening agent in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer.

In another non-limiting aspect of the present disclosure, the wax, when included in the bitumen compound layer, is about 0.01-15 wt. % (and all values and ranges therebetween) of the bitumen compound layer. In one non-limiting formulation, the wax (when used) constitutes 0.01-5 wt. % of the bitumen compound layer. In another non-limiting formulation, the wax (when used) constitutes 0.05-1 wt. % of the bitumen compound layer. In another non-limiting formulation, the weight percent of wax in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the wax can include paraffin wax, etc.; however, other or additional wax can be used.

In another non-limiting aspect of the present disclosure, the acid, when included in the bitumen compound layer, is about 0.01-15 wt. % (and all values and ranges therebetween) of the bitumen compound layer. In one non-limiting formulation, the acid (when used) constitutes 0.01-5 wt. % of the bitumen compound layer. In another non-limiting formulation, the acid (when used) constitutes 0.05-1 wt. % of the bitumen compound layer. In another non-limiting formulation, the weight percent of acid in the bitumen compound layer (when used) is less than a) the weight percent of the primary hydrocarbon compound in the bitumen compound layer, b) the weight percent of filler (when used) in the bitumen compound, c) the weight percent of the APP in the bitumen compound layer, d) the weight percent of the resin material in the bitumen compound layer, and e) the weight percent of IPP (when used) in the bitumen compound layer. In one non-limiting formulation, the acid can include stearic acid, etc.; however, other or additional acid can be used.

In another non-limiting aspect of the present disclosure, the reinforcement fibers, when included in the bitumen compound layer, are about 0.01-25 wt. % (and all values and ranges therebetween) of the bitumen compound layer. In one non-limiting formulation, the reinforcement fibers (when used) constitute 0.05-20 wt. % of the bitumen compound layer. In another non-limiting formulation, the reinforcement fibers (when used) constitute 0.05-18 wt. % of the bitumen compound layer. In another non-limiting formulation, the weight percent of reinforcement fibers in the bitumen compound layer (when used) is less than a) the weight percent of the primary hydrocarbon compound in the bitumen compound layer, and b) the weight percent of filler (when used) in the bitumen compound. In one non-limiting formulation, the reinforcement fibers can include one or more of Kevlar®, carbon fibers, fiberglass, boron fibers, etc.; however, other or additional tackifier can be used. The reinforcement fibers are non-woven fibers that have a length of no more than 10 mm (e.g., 0.1-10 mm and all values and ranges therebetween) and the reinforcement fibers are dispersed in the bitumen compound layer.

In another non-limiting aspect of the present disclosure, the weight percent of the primary hydrocarbon compound in the bitumen compound layer is greater than the combined weight percent of a) filler (when used), and b) APP in the bitumen compound layer.

In another non-limiting aspect of the present disclosure, the weight percent of the primary hydrocarbon compound in the bitumen compound layer is greater than the combined weight percent of a) filler (when used), b) APP in the bitumen compound layer, and c) IPP (when used) in the bitumen compound layer.

In another non-limiting aspect of the present disclosure, the weight percent of the primary hydrocarbon compound in the bitumen compound layer is greater than the combined weight percent of a) filler (when used), b) APP in the bitumen compound layer, c) IPP (when used) in the bitumen compound layer, and d) the weight percent of the resin material in the bitumen compound layer.

In another non-limiting aspect of the present disclosure, the weight percent of the primary hydrocarbon compound in the bitumen compound layer is greater than the combined weight percent of a) filler (when used), b) APP in the bitumen compound layer, and c) the weight percent of the resin material in the bitumen compound layer.

In another non-limiting aspect of the present disclosure, the thickness of the entire bitumen compound layer (which includes the fiber reinforcement layer that is partially or fully embedded in the bitumen compound layer) is generally 10-250 mil (0.01-0.25 in.) (and all values and ranges therebetween). In one non-limiting arrangement, the thickness of the entire bitumen compound layer (which includes the fiber reinforcement layer that is partially or fully embedded in the bitumen compound layer) is generally 20-150 mil. In another non-limiting arrangement, the thickness of the entire bitumen compound layer (which includes the fiber reinforcement layer that is partially or fully embedded in the bitumen compound layer) is generally 40-130 mil. In another non-limiting arrangement, the thickness of the entire bitumen compound layer (which includes the fiber reinforcement layer that is partially or fully embedded in the bitumen compound layer) is generally 80-100 mil.

In another non-limiting aspect of the present disclosure, the bitumen compound layer forms a waterproofing layer on the reinforced bitumen roofing membrane.

In another non-limiting aspect of the present disclosure, the bitumen compound layer includes a) primary hydrocarbon compound, b) APP, c) resin material, d) optionally IPP, and e) optionally filler. In one non-limiting embodiment, the primary hydrocarbon compound can be fully formed of bitumen, or can be a mixture of bitumen and coal tar. In one non-limiting example, the primary hydrocarbon compound is 60-100 wt. % (and all values and ranges therebetween) bitumen. In one non-limiting specific formulation, the bitumen that forms all or a portion of the primary hydrocarbon compound is asphalt (e.g., 125-225 Pen asphalt). The primary hydrocarbon compound constitutes 25-90 wt. % (and all values and ranges therebetween) of the bitumen compound layer. The APP constitutes 1-30 wt. % (and all values and ranges therebetween) of the bitumen compound layer. The resin material constitutes 1-25 wt. % (and all values and ranges therebetween) of the bitumen compound layer. Non-limiting resin materials are C4 resins, C5 resins, and/or C6 resins. Non-limiting resins includes pentadiene resins, polyisobutylene resins, polyisobutene resins, C5 petroleum resins, C5 hydrocarbon resins, aromatic modified C5 hydrocarbon resin, aliphatic C5 petroleum hydrocarbon resin, etc. In another non-limiting embodiment, the resin material has a molecular weight (MW) of 600-100,000 g/mol. (and all values and ranges therebetween). The IPP material constitutes 0-20 wt. % (and all values and ranges therebetween) of the bitumen compound layer. The filler constitutes 0-66 wt. % (and all values and ranges therebetween) of the bitumen compound layer. In one non-limiting embodiment, the filler can include one or more of calcium carbonate, silica, talc, carbon black, clay, etc. The bitumen compound layer can optionally include one or more additional components (e.g., secondary polymer, hydrocarbon process oil, antioxidant, UV stabilizer, cross-linker, biocide, coloring agent, metal flakes, adhesion enhancer, fire retardant, tackifying agent, softening agent, wax, acid, reinforcement fibers, etc.).

Non-limiting examples of the composition of the bitumen compound layer (absent the fiber reinforcement layer, the optional release liner that is releasably positioned on the bottom surface of the bitumen roofing membrane, and the optional release film that is releasably positioned on the top surface of the fiber reinforcement layer or bitumen compound layer) are as follows:

### Example 1

| | |
|---|---|
| Primary hydrocarbon compound | 25-90 wt. % |
| APP | 1-30 wt. % |
| Resin Material | 1-25 wt. % |
| Filler | 0-66 wt. % |
| IPP | 0-20 wt. % |
| Secondary Polymer | 0-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. % |

| | |
|---|---|
| Primary hydrocarbon compound | 25-90 wt. % |
| APP | 1-30 wt. % |
| Resin Material | 1-25 wt. % |
| Filler | 0.5-66 wt. % |
| IPP | 0.1-20 wt. % |
| Secondary Polymer | 0.1-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. % |

| | |
|---|---|
| Primary hydrocarbon compound (125-225 Pen) | 25-90 wt. % |
| APP | 1-30 wt. % |
| Resin Material (e.g., C4 resin, C5 resin, C6 resin) | 1-25 wt. % |
| Filler (e.g., calcium carbonate, silica, talc, | 0.5-66 wt. % |
| carbon black, clay, etc.) | |
| IPP | 0.1-20 wt. % |
| Secondary Polymer | 0.1-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. % |

| | |
|---|---|
| Primary hydrocarbon compound (125-225 Pen) | 30-80 wt. % |
| APP | 5-20 wt. % |
| Resin Material (e.g., C4 resin, C5 resin, C6 resin) | 2-20 wt. % |
| Filler (e.g., calcium carbonate, silica, talc, | 2-45 wt. % |
| carbon black, clay, etc.) | |
| IPP | 0.5-12 wt. % |
| Secondary Polymer | 0.5-12 wt. % |
| Hydrocarbon Process Oil | 0-10 wt. % |
| Antioxidant | 0-10 wt. % |
| UV Stabilizer | 0-10 wt. % |
| Cross-Linker | 0-10 wt. % |
| Biocide | 0-10 wt. % |
| Coloring Agent | 0-5 wt. % |
| Metal Flakes | 0-10 wt. % |
| Adhesion Enhancer | 0-5 wt. % |
| Fire Retardant | 0-15 wt. % |
| Tackifying Agent | 0-10 wt. % |
| Softening Agent | 0-10 wt. % |
| Wax | 0-10 wt. % |
| Acid | 0-10 wt. % |
| Reinforcement Fibers | 0-15 wt. % |

| | |
|---|---|
| Primary hydrocarbon compound (150-200 Pen) | 35-60 wt. % |
| APP | 6-18 wt. % |
| Resin Material (e.g., C4 resin, C5 resin, C6 resin) | 4-16 wt. % |
| Filler (e.g., calcium carbonate, silica, talc, | 2-40 wt. % |
| carbon black, clay, etc.) | |
| IPP | 1-10 wt. % |
| Secondary Polymer | 0-10 wt. % |
| Hydrocarbon Process Oil | 0-5 wt. % |
| Antioxidant | 0-5 wt. % |
| UV Stabilizer | 0-5 wt. % |
| Cross-Linker | 0-5 wt. % |
| Biocide | 0-5 wt. % |
| Coloring Agent | 0-5 wt. % |
| Metal Flakes | 0-5 wt. % |
| Adhesion Enhancer | 0-5 wt. % |
| Fire Retardant | 0-10 wt. % |
| Tackifying Agent | 0-5 wt. % |
| Softening Agent | 0-5 wt. % |
| Wax | 0-5 wt. % |
| Acid | 0-5 wt. % |
| Reinforcement Fibers | 0-10 wt. % |

| | |
|---|---|
| Primary hydrocarbon compound (150-200 Pen) | 40-55 wt. % |
| APP | 8-15 wt. % |
| Resin Material (e.g., C4 resin, C5 resin, C6 resin) | 5-10 wt. % |
| Filler (e.g., calcium carbonate, silica, talc | 2-35 wt. % |
| carbon black, clay, etc.) | |
| IPP | 2.5-10 wt. % |
| Secondary Polymer (e.g., APAO, PE, | 0-8 wt. % |
| PP/PE copolymer, SEBS, SBR), etc.) | |
| Secondary Polymer | 2-8 wt. % |
| Hydrocarbon Process Oil | 0-5 wt. % |
| Antioxidant | 0-5 wt. % |
| UV Stabilizer | 0-5 wt. % |
| Cross-Linker | 0-5 wt. % |
| Biocide | 0-5 wt. % |
| Coloring Agent | 0-5 wt. % |
| Metal Flakes | 0-5 wt. % |
| Adhesion Enhancer | 0-5 wt. % |
| Fire Retardant | 0-10 wt. % |
| Tackifying Agent | 0-5 wt. % |
| Softening Agent | 0-5 wt. % |
| Wax | 0-5 wt. % |
| Acid | 0-5 wt. % |
| Reinforcement Fibers | 0-10 wt. % |

### Example 7

| | |
|---|---|
| Primary hydrocarbon compound (160-180 Pen) | 45-52 wt. % |
| APP | 8-12 wt. % |
| Resin Material (e.g., C$ resin and/or C5 resin) | 6-10 wt. % |
| Filler (e.g., calcium carbonate, silica, talc, | 2-30 wt. % |
| carbon black, clay, etc.) | |
| IPP | 2.5-10 wt. % |
| Secondary Polymer (e.g., APAO, PE, | 0-5 wt. % |
| PP/PE copolymer, SEBS, SBR), etc.) | |
| Hydrocarbon Process Oil | 0-3 wt. % |
| Antioxidant | 0-2 wt. % |
| UV Stabilizer | 0-2 wt. % |
| Cross-Linker | 0-3 wt. % |
| Biocide | 0-2 wt. % |
| Coloring Agent | 0-2 wt. % |
| Metal Flakes | 0-4 wt. % |
| Adhesion Enhancer | 0-2 wt. % |
| Fire Retardant | 0-5 wt. % |
| Tackifying Agent | 0-2 wt. % |
| Softening Agent | 0-2 wt. % |
| Wax | 0-2 wt. % |
| Acid | 0-2 wt. % |
| Reinforcement Fibers | 0-5 wt. % |

In Examples 1-7, it will be appreciated that all of the above ranges include any value between the range and any other range that is between the ranges set forth above.

### The Fiber Reinforcement Layer

The fiber reinforcement layer is used as a reinforcement layer for the reinforced bitumen roofing membrane. The fiber reinforcement layer is partially or fully encapsulated in the bitumen compound layer. In one non-limiting embodiment, the fiber reinforcement layer is fully encapsulated in the bitumen compound layer.

In another non-limiting aspect of the present disclosure, the fiber reinforcement layer spans 50-100% (and all values and ranges therebetween) of the width of the reinforced bitumen roofing membrane, also generally spans 50-100% (and all values and ranges therebetween) of the longitudinal length of the reinforced bitumen roofing membrane. In one non-limiting embodiment, the fiber reinforcement layer generally spans 80-100% of the width of the reinforced bitumen roofing membrane, and also generally spans 80-100% of the longitudinal length of the reinforced bitumen roofing membrane.

In another non-limiting aspect of the present disclosure, the reinforced bitumen roofing membrane can optionally include a lap line region on one or more sides of the reinforced bitumen roofing membrane. In one non-limiting configuration, the lap line region is absent the fiber reinforcement layer. In another non-limiting configuration, the width of the lap line region (when used) is generally 0.5-6 in. (and all values and ranges therebetween), typically the width of the lap line region is 1-5 in., and more typically, the width of the lap line region is 3-4 in.

In another non-limiting aspect of the present disclosure, the fiber reinforcement layer may be a woven mat, a non-woven mat, a mat formed by non-overlapping fibers (e.g., rovings, etc.), or a mat formed by overlapping fibers. In one non-limiting embodiment, the fiber reinforcement layer is a woven mat.

In another non-limiting aspect of the present disclosure, the fiber material used to at least partially form the fiber reinforcement layer is partially or fully formed of fibers that are 0.2-50 in. in length (and all values and ranges therebetween). In another non-limiting configuration, the fiber material used to at least partially form the fiber reinforcement layer is partially or fully formed of fibers that are 0.3-20 in. in length.

In another non-limiting aspect of the present disclosure, the fiber material used to at least partially form the fiber reinforcement layer can optionally be partially or fully held together by a binder (e.g., polymeric binder, acrylic binder, etc.).

In another non-limiting aspect of the present disclosure, the fiber reinforcement layer is formed of a plurality of fibers that are oriented in multiple directions from one another (e.g., multi-directional fiber mat) and such fibers.

In another non-limiting aspect of the present disclosure, the fiber reinforcement layer can be rolled into a roll have a diameter of 8 inches or less without damaging the fiber reinforcement layer.

In another non-limiting aspect of the present disclosure, the fiber reinforcement layer generally has an average thickness of at least 0.1 mm, and typically has a thickness of 0.1-6 mm (and all values and ranges therebetween). In one non-limiting configuration, the fiber reinforcement layer has an average thickness of 0.5-5 mm. In another non-limiting configuration, the fiber reinforcement layer has an average thickness of 0.8-3 mm.

In another non-limiting aspect of the present disclosure, the fiber reinforcement layer is formed from one or more materials (e.g., fiberglass, nylon, polyester, cotton, silk, wool, hemp, straw, bamboo, flax, jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, aromatic polyamide or aramid fibers (e.g., Kevlar™, Twaron™, etc., and any blend of these materials). In one non-limiting embodiment, the fiber reinforcement layer is partially or fully formed of or includes fiberglass fibers and/or polyester fibers. In one specific non-limiting embodiment, the fiber reinforcement layer is fully formed of fiberglass fibers. In another specific non-limiting embodiment, the fiber reinforcement layer is fully formed of polyester fibers. In another non-limiting embodiment, the fiber reinforcement layer is partially or fully formed of or includes both fiberglass fibers and polyester fibers. In one specific non-limiting embodiment, the weight ratio of fiberglass fibers to polyester fibers in the fiber reinforcement layer is 0.01:1 to 1:0.01 (and all values and ranges therebetween). In another specific non-limiting embodiment, the fiber reinforcement layer is fully formed of both fiberglass fibers and polyester fibers, and the weight ratio of fiberglass fibers to polyester fibers in the fiber reinforcement layer is 0.01:1 to 1:0.01 (and all values and ranges therebetween).

In another non-limiting aspect of the present disclosure, the fiber reinforcement layer can be optionally be formed, treated, etc., to be wick resistant to inhibit or prevent moisture from moving through the fiber reinforcement layer. As such, the fibers of the fiber reinforcement layer can be a) formed of a wick-resistant material; b) the knitting together of the fibers can be tight to inhibit or resist moisture penetration or wicking of moisture through the fiber reinforcement layer; and/or c) the fibers and/or the fiber reinforcement layer itself can be coated with a material that inhibits or resists moisture penetration or wicking of moisture through the fiber reinforcement layer.

In another non-limiting aspect of the present disclosure, the fiber reinforcement layer can optionally have fire-retardant properties. In non-limiting configuration, the fiber reinforcement layer can optionally be pre-treated and/or post-treated with one or more fire-retardant materials (e.g., halogenated compound containing coatings, expandable graphite containing coatings, etc.).

### The Release Liner on Underside

A release liner can be optionally applied to the bottom surface of the bitumen compound layer or form the bottom surface of the reinforced bitumen roofing membrane. Such release liner can be formed of a paper (e.g. kraft paper, super calendared kraft paper, clay coated kraft paper, polymer coated kraft paper, glazed paper, etc.) or a polymeric film (e.g., PET film, polypropylene film, polyolefins film, polyethylene films, PP films, etc.) or a paper that is coated with a polymeric film. The thickness of the release liner is generally 0.2-50 mil (and all values and ranges therebetween). In one non-limiting configuration, the thickness of the release liner (when used) is 1-10 mil.

### The Release Film on Topside

A release film can be optionally applied to the top surface of the bitumen compound layer or form the top surface of the reinforced bitumen roofing membrane. Such release film can be formed of a paper (e.g. kraft paper, super calendared kraft paper, clay coated kraft paper, polymer coated kraft paper, glazed paper, etc.) or a polymeric film (e.g., PET film, polypropylene film, polyolefins film, polyethylene films, PP films, etc.) or a paper that is coated with a polymeric film. The thickness of the release film is generally 0.2-50 mil (and all values and ranges therebetween). In one non-limiting configuration, the thickness of the release film (when used) is 1-10 mil.

It is one non-limiting object of the disclosure to provide a self-adhering reinforced APP (atactic polypropylene) bitumen roofing membrane or APP and IPP (Isotactic Polypropylene [e.g., Isotactic PolyPropylene Homopolymer]) bitumen roofing membrane.

It is another non-limiting object of the disclosure to provide a reinforced bitumen roofing membrane that includes 1) a bitumen compound layer that includes APP, 2) a fiber reinforcement layer, 3) an optional release liner that is releasably positioned on the bottom surface of the bitumen roofing membrane, and/or 4) an optional release film that is releasably positioned on the top surface of the fiber reinforcement layer or bitumen compound layer.

It is another non-limiting object of the disclosure to provide a reinforced bitumen roofing membrane that includes a bitumen compound layer that includes a) primary hydrocarbon compound (e.g., bitumen or asphalt, coal tar); b) primary polymer modifier that includes APP [Atactic Polypropylene]; and c) C4-C9 resin material (e.g., cis/trans 1,3-pentadienes, 2-methyl-2-butene, cyclopentene, cyclopentadiene, dicyclopentadiene, polyisobutene, cycloalphaliphatic hydrocarbon resin, aliphatic C-5 to C-9 hydrocarbon resin, aromatically modified C-5 to C-9 hydrocarbon resin, etc.).

It is another non-limiting object of the disclosure to provide a reinforced bitumen roofing membrane that includes a bitumen compound layer that includes one or more optional additives such as 1) filler (e.g., calcium carbonate, chalk, clay, dolomite, kaolin, silica, talc, etc.); 2) IPP [Isotactic Polypropylene]; 3) secondary polymer modifier (e.g., APAO [Amorphous Polyolefin], EVA [Ethylene Vinyl Acetate], EBA [Ethylene Butyl Acrylate], PPA [Polyphthalamide], PPI [Polymeric Polyisocyanate], PE [Polyethylene], PP [Polypropylene] that is different from the APP and IPP, SEBS [Styrene Ethylene Butadiene Styrene], SBS [Styrene Butadiene Styrene], SIS [Styrene-Isoprene-Styrene], thermoplastic urethane [TPU], etc.); 4) process oil (e.g., naphthenic oil, paraffinic oil, etc.); 5) tackifying agent; 6) antioxidant; 7) UV stabilizer; 8) cross-linkers; 9) biocide; 10) coloring agent; 11) metal flakes; 12) adhesion enhancer; 13) fire retardant (e.g., alumina trihydrate, ammonium polyphosphate, etc.); 14) softening agent; 15) wax (e.g., paraffin wax, etc.); 16) acid (e.g., stearic acid, etc.); and/or 17) reinforcement fibers (e.g., Kevlar®, carbon fibers, fiberglass, boron fibers, etc.).

It is another non-limiting object of the disclosure to provide a reinforced bitumen roofing membrane that includes a bitumen compound layer that includes a primary hydrocarbon compound that constitutes 25-90 wt. % of the bitumen compound layer.

It is another non-limiting object of the disclosure to provide a reinforced bitumen roofing membrane that includes a bitumen compound layer that includes APP [Atactic Polypropylene] that constitutes 1-30 wt. % of the bitumen compound layer.

It is another non-limiting object of the disclosure to provide a reinforced bitumen roofing membrane that includes a bitumen compound layer that includes resin material that constitutes 1-25 wt. % of the bitumen compound layer.

It is another non-limiting object of the disclosure to provide a reinforced bitumen roofing membrane that includes a bitumen compound layer that optionally includes filler that constitutes about 0.5-66 wt. % of the bitumen compound layer.

It is another non-limiting object of the disclosure to provide a reinforced bitumen roofing membrane that includes a bitumen compound layer that optionally includes IPP [Isotactic Polypropylene] that constitutes about 0.01-20 wt. % of the bitumen compound layer.

It is another non-limiting object of the disclosure to provide a reinforced bitumen roofing membrane that includes a bitumen compound layer that optionally includes secondary polymer modifier that constitutes about 0.01-20 wt. % of the bitumen compound layer.

It is another non-limiting object of the disclosure to provide a reinforced bitumen roofing membrane that includes a fiber reinforcement layer that is used as a reinforcement layer for the reinforced bitumen roofing membrane.

It is another non-limiting object of the disclosure to provide a reinforced bitumen roofing membrane that includes a release liner that can be optionally applied to the bottom surface of the bitumen compound layer.

It is another non-limiting object of the disclosure to provide a reinforced bitumen roofing membrane that includes a release film that can be optionally applied to the top surface of the bitumen compound layer.

It is another non-limiting object of the disclosure to provide a reinforced bitumen roofing membrane that includes 30-99 wt. % bitumen compound layer (and all values and ranges therebetween), 1-70 wt. % fiber reinforcement layer (and all values and ranges therebetween), 0-5 wt. % release liner (and all values and ranges therebetween), and wherein the release liner, and 0-5 wt. % release film (and all values and ranges therebetween), and wherein the release liner, when used, is positioned on the bottom surface of the reinforced bitumen roofing membrane, and wherein the release film, when used, is positioned on the top surface of the reinforced bitumen roofing membrane.

It is another non-limiting object of the disclosure to provide a reinforced bitumen roofing membrane that includes a bitumen compound layer and a fiber reinforcement layer, and wherein the fiber reinforcement layer is partially saturated (e.g., 5-99.999% saturated and all values and ranges therebetween) or fully saturated with the bitumen compound layer.

It is another non-limiting object of the disclosure to provide a method for applying a roof membrane to a roof system comprising a) providing a first sheet of self-adhering reinforced bitumen roofing membrane; the self-adhering reinforced bitumen roofing membrane includes a bitumen compound layer that includes atactic polypropylene (APP), and a fiber reinforcement layer; and b) positioning a bottom surface of the first sheet of self-adhering reinforced bitumen roofing membrane on a top surface of a roof substrate of the roof system; and wherein the bottom surface of the first sheet of self-adhering reinforced bitumen roofing membrane has a tacky surface that adhesively connects the bottom surface of the first sheet of self-adhering reinforced bitumen roofing membrane to the top surface of the roof substrate of the roof system when the first sheet of self-adhering reinforced bitumen roofing membrane is pressed against the top surface of the roof substrate of the roof system.

It is another non-limiting object of the disclosure to provide a method for applying a roof membrane to a roof system wherein the first sheet of self-adhering reinforced bitumen roofing membrane is pressed against the top surface of the roof substrate of the roof system by one or more processes selected from i) walking on a top surface of the first sheet of self-adhering reinforced bitumen roofing membrane while the first sheet of self-adhering reinforced bitumen roofing membrane is position the top surface of the roof substrate of the roof system, ii) rolling a roller the top surface of the first sheet of self-adhering reinforced bitumen roofing membrane while the first sheet of self-adhering reinforced bitumen roofing membrane is position the top surface of the roof substrate of the roof system, and/or iii) applying a weighted structures on a top surface of the first sheet of self-adhering reinforced bitumen roofing membrane while the first sheet of self-adhering reinforced bitumen roofing membrane is position the top surface of the roof substrate of the roof system.

It is another non-limiting object of the disclosure to provide a method for applying a roof membrane to a roof system wherein the first sheet of self-adhering reinforced bitumen roofing membrane includes a release liner on the bottom surface of the first sheet of self-adhering reinforced bitumen roofing membrane, and further including the step of removing the release liner on the bottom surface of the first sheet of self-adhering reinforced bitumen roofing membrane prior to the step of positioning a bottom surface of the first sheet of self-adhering reinforced bitumen roofing membrane on a top surface of a roof substrate of the roof system.

It is another non-limiting object of the disclosure to provide a method for applying a roof membrane to a roof system wherein the first sheet of self-adhering reinforced bitumen roofing membrane includes a release film on a top surface of the first sheet of self-adhering reinforced bitumen roofing membrane, and further including the step of removing the release film on the top surface of the first sheet of self-adhering reinforced bitumen roofing membrane after the step of positioning a bottom surface of the first sheet of self-adhering reinforced bitumen roofing membrane on a top surface of a roof substrate of the roof system.

It is another non-limiting object of the disclosure to provide a method for applying a roof membrane to a roof system further including the steps of a) providing a second sheet of self-adhering reinforced bitumen roofing membrane; the first and second sheets of self-adhering reinforced bitumen roofing membrane formed of the same materials; b) positioning the second sheet of self-adhering reinforced bitumen roofing membrane next so the first sheet of self-adhering reinforced bitumen roofing membrane such that a portion of a bottom surface of the second sheet of self-adhering reinforced bitumen roofing membrane overlaps a top surface of the first sheet of self-adhering reinforced bitumen roofing membrane and a tacky surface of the bottom surface of the second sheet of self-adhering reinforced bitumen roofing membrane adhesively connects to the top surface of the first sheet of self-adhering reinforced bitumen roofing membrane in the overlapped regions.

It is another non-limiting object of the disclosure to provide a method for applying a roof membrane to a roof system wherein 25-90 wt. % of the bitumen compound layer of the first sheet of self-adhering reinforced bitumen roofing membrane includes primary hydrocarbon compound; 1-30 wt. % of the bitumen compound layer of the first sheet of self-adhering reinforced bitumen roofing membrane includes the APP; 1-25 wt. % of the bitumen compound layer of the first sheet of self-adhering reinforced bitumen roofing membrane includes resin material; 0.1-20 wt. % of the bitumen compound layer of the first sheet of self-adhering reinforced bitumen roofing membrane includes IPP, and e) 0-66 wt. % of the bitumen compound layer of the first sheet of self-adhering reinforced bitumen roofing membrane includes filler; the bitumen compound layer constitutes 30-99 wt. % of the first sheet of self-adhering reinforced bitumen roofing membrane; the fiber reinforcement constitutes 1-70 wt. % of the first sheet of self-adhering reinforced bitumen roofing membrane; a release liner constitutes 0-5 wt. % of the first sheet of self-adhering reinforced bitumen roofing membrane and which release liner is positioned on a bottom surface of the bitumen compound layer or the fiber reinforcement; and a release film constitutes 0-5 wt. % of the first sheet of self-adhering reinforced bitumen roofing membrane and which release film is positioned on a top surface of the bitumen compound layer or the fiber reinforcement; 60-100 wt. % of the primary hydrocarbon compound is bitumen; the resin material includes one or more of C4 resins, C5 resins, and/or C6 resins.

Other objects, advantages, and novel features of the present invention will become apparent from the following detailed description of the invention when considered in conjunction with the accompanying drawing.

### BRIEF DESCRIPTION OF THE DRAWING

Non-limiting and non-exhaustive embodiments are described with reference to the following drawing, wherein like labels refer to like parts throughout the various views unless otherwise specified. The sizes and relative positions of elements in the drawing is not necessarily drawn to scale. For example, the shapes of various elements are selected, enlarged, and positioned to improve drawing legibility. The particular shapes of the elements as drawn have been selected for ease of recognition in the drawing. Reference may now be made to the drawing, which illustrate various embodiments that the disclosure may take in physical form and in certain parts and arrangement of parts wherein:

FIG. 1 is a cross-section view of a roofing and/or siding material in accordance with the present invention.

### DETAILED DESCRIPTION OF THE PREFERRED EMBODIMENTS

A more complete understanding of the articles/devices, processes and components disclosed herein can be obtained by reference to the accompanying drawing. The figure is merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawing and is not intended to define or limit the scope of the disclosure. In the drawing and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figure may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

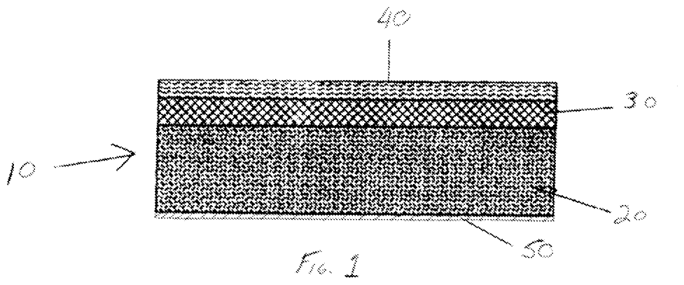

Referring now to the drawing wherein the showings are for the purpose of illustrating non-limiting embodiments of the disclosure only and not for the purpose of limiting same, FIG. 1 illustrates a self-adhering reinforced bitumen roofing membrane 10 in accordance with the present disclosure. The self-adhering reinforced bitumen roofing membrane 10 includes a bitumen compound layer 20 that includes atactic polypropylene (APP), a fiber reinforcement layer 30, an optional release film 40, and an optional release layer 50.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

The description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. A self-adhering reinforced bitumen roofing membrane that includes a) a bitumen compound layer that includes atactic polypropylene (APP), and b) a fiber reinforcement layer.

2. The self-adhering reinforced bitumen roofing membrane as defined in claim 1, wherein a) 25-90 wt. % of said bitumen compound layer includes primary hydrocarbon compound, b) 1-30 wt. % of said bitumen compound layer includes said APP, c) 1-25 wt. % of said bitumen compound layer includes resin material, d) 0-20 wt. % of said bitumen compound layer includes IPP, and e) 0-66 wt. % of said bitumen compound layer includes filler.

3. The self-adhering reinforced bitumen roofing membrane as defined in claim 1, wherein said bitumen compound layer constitutes 30-99 wt. % of said self-adhering reinforced bitumen roofing membrane, said fiber reinforcement constitutes 1-70 wt. % of said self-adhering reinforced bitumen roofing membrane, a release liner constitutes 0-5 wt. % of said self-adhering reinforced bitumen roofing membrane and which release liner is positioned on a bottom surface of said bitumen compound layer or said fiber reinforcement, and release film constitutes 0-5 wt. % of said self-adhering reinforced bitumen roofing membrane and which release film is positioned on a top surface of said bitumen compound layer or said fiber reinforcement.

4. The self-adhering reinforced bitumen roofing membrane as defined in claim 1, wherein said fiber reinforcement layer is partially or fully saturated said bitumen compound layer.

5. The self-adhering reinforced bitumen roofing membrane as defined in claim 1, wherein 60-100 wt. % of said primary hydrocarbon compound is bitumen.

6. The self-adhering reinforced bitumen roofing membrane as defined in claim 1, wherein said resin material includes one or more of C4 resins, C5 resins, and/or C6 resins.

7. The self-adhering reinforced bitumen roofing membrane as defined in claim 1, wherein 0.1-20 wt. % of said bitumen compound layer includes isotactic polypropylene (IPP).

8. The self-adhering reinforced bitumen roofing membrane as defined in claim 1, wherein 0.1-66 wt. % of said bitumen compound layer includes filler.

9. The self-adhering reinforced bitumen roofing membrane as defined in claim 1, wherein said bitumen compound layer comprises by weight percent:

| | |
|---|---|
| Primary hydrocarbon compound | 25-90 wt. % |
| APP | 1-30 wt. % |
| Resin Material | 1-25 wt. % |
| Filler | 0-66 wt. % |
| IPP | 0-20 wt. % |
| Secondary Polymer | 0-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. %. |

10. The self-adhering reinforced bitumen roofing membrane as defined in claim 1, wherein said bitumen compound layer comprises by weight percent:

| | |
|---|---|
| Primary hydrocarbon compound | 25-90 wt. % |
| APP | 1-30 wt. % |
| Resin Material | 1-25 wt. % |
| Filler | 0.5-66 wt. % |
| IPP | 0.1-20 wt. % |
| Secondary Polymer | 0.1-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. %. |

11. The self-adhering reinforced bitumen roofing membrane as defined in claim 1, wherein said bitumen compound layer comprises by weight percent:

| | |
|---|---|
| Primary hydrocarbon compound | 25-90 wt. % |
| APP | 1-30 wt. % |
| Resin Material that is or | 1-25 wt. % |
| includes a C4 resin, C5 resin | |
| and/or C6 resin | |
| Filler | 0.5-66 wt. % |
| IPP | 0.1-20 wt. % |
| Secondary Polymer | 0.1-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. %. |

12. The self-adhering reinforced bitumen roofing membrane as defined in claim 1, wherein said bitumen compound layer comprises by weight percent:

| | |
|---|---|
| Primary hydrocarbon compound | 30-80 wt. % |
| APP | 5-20 wt. % |
| Resin Material that is or | 2-20 wt. % |
| includes a C4 resin, C5 resin | |
| and/or C6 resin | |
| Filler | 2-45 wt. % |
| IPP | 0.5-12 wt. % |
| Secondary Polymer | 0.5-12 wt. % |
| Hydrocarbon Process Oil | 0-10 wt. % |
| Antioxidant | 0-10 wt. % |
| UV Stabilizer | 0-10 wt. % |
| Cross-Linker | 0-10 wt. % |
| Biocide | 0-10 wt. % |
| Coloring Agent | 0-5 wt. % |
| Metal Flakes | 0-10 wt. % |
| Adhesion Enhancer | 0-5 wt. % |
| Fire Retardant | 0-15 wt. % |
| Tackifying Agent | 0-10 wt. % |
| Softening Agent | 0-10 wt. % |
| Wax | 0-10 wt. % |
| Acid | 0-10 wt. % |
| Reinforcement Fibers | 0-15 wt. %. |

13. The self-adhering reinforced bitumen roofing membrane as defined in claim 1, wherein said bitumen compound layer comprises by weight percent:

| | |
|---|---|
| Primary hydrocarbon compound | 35-60 wt. % |
| APP | 6-18 wt. % |
| Resin Material that is or | 4-16 wt. % |
| includes a C4 resin, C5 resin | |
| and/or C6 resin | |
| Filler | 2-40 wt. % |
| IPP | 1-10 wt. % |
| Secondary Polymer | 1-10 wt. % |
| Hydrocarbon Process Oil | 0-5 wt. % |
| Antioxidant | 0-5 wt. % |
| UV Stabilizer | 0-5 wt. % |
| Cross-Linker | 0-5 wt. % |
| Biocide | 0-5 wt. % |
| Coloring Agent | 0-5 wt. % |
| Metal Flakes | 0-5 wt. % |
| Adhesion Enhancer | 0-5 wt. % |
| Fire Retardant | 0-10 wt. % |
| Tackifying Agent | 0-5 wt. % |
| Softening Agent | 0-5 wt. % |
| Wax | 0-5 wt. % |
| Acid | 0-5 wt. % |
| Reinforcement Fibers | 0-10 wt. %. |

14. The self-adhering reinforced bitumen roofing membrane as defined in claim 1, wherein said bitumen compound layer comprises by weight percent:

| | |
|---|---|
| Primary hydrocarbon compound | 40-55 wt. % |
| APP | 8-15 wt. % |
| Resin Material that is or | 5-10 wt. % |
| includes a C4 resin, C5 resin | |
| and/or C6 resin | |
| Filler | 2-35 wt. % |
| IPP | 2.5-10 wt. % |
| Secondary Polymer | 2-8 wt. % |
| Secondary Polymer | 2-8 wt. % |
| Hydrocarbon Process Oil | 0-5 wt. % |
| Antioxidant | 0-5 wt. % |
| UV Stabilizer | 0-5 wt. % |
| Cross-Linker | 0-5 wt. % |
| Biocide | 0-5 wt. % |
| Coloring Agent | 0-5 wt. % |
| Metal Flakes | 0-5 wt. % |
| Adhesion Enhancer | 0-5 wt. % |
| Fire Retardant | 0-10 wt. % |
| Tackifying Agent | 0-5 wt. % |
| Softening Agent | 0-5 wt. % |
| Wax | 0-5 wt. % |
| Acid | 0-5 wt. % |
| Reinforcement Fibers | 0-10 wt. %. |

15. The self-adhering reinforced bitumen roofing membrane as defined in claim 1, wherein said bitumen compound layer comprises by weight percent:

| | |
|---|---|
| Primary hydrocarbon compound | 45-52 wt. % |
| APP | 8-12 wt. % |
| Resin Material that is or | 6-10 wt. % |
| includes C5 resin | |
| Filler | 2-30 wt. % |
| IPP | 2.5-10 wt. % |
| Secondary Polymer | 2-5 wt. % |
| Hydrocarbon Process Oil | 0-3 wt. % |
| Antioxidant | 0-2 wt. % |
| UV Stabilizer | 0-2 wt. % |
| Cross-Linker | 0-3 wt. % |
| Biocide | 0-2 wt. % |
| Coloring Agent | 0-2 wt. % |
| Metal Flakes | 0-4 wt. % |
| Adhesion Enhancer | 0-2 wt. % |
| Fire Retardant | 0-5 wt. % |
| Tackifying Agent | 0-2 wt. % |
| Softening Agent | 0-2 wt. % |
| Wax | 0-2 wt. % |
| Acid | 0-2 wt. % |
| Reinforcement Fibers | 0-5 wt. %. |

16. A self-adhering reinforced bitumen roofing membrane that includes a) a bitumen compound layer that includes atactic polypropylene (APP), and b) a fiber reinforcement layer; 25-90 wt. % of said bitumen compound layer includes primary hydrocarbon compound; 1-30 wt. % of said bitumen compound layer includes said APP; 1-25 wt. % of said bitumen compound layer includes resin material; 0.1-20 wt. % of said bitumen compound layer includes IPP, and e) 0-66 wt. % of said bitumen compound layer includes filler; said bitumen compound layer constitutes 30-99 wt. % of said self-adhering reinforced bitumen roofing membrane; said fiber reinforcement constitutes 1-70 wt. % of said self-adhering reinforced bitumen roofing membrane; a release liner constitutes 0-5 wt. % of said self-adhering reinforced bitumen roofing membrane and which release liner is positioned on a bottom surface of said bitumen compound layer or said fiber reinforcement; and a release film constitutes 0-5 wt. % of said self-adhering reinforced bitumen roofing membrane and which release film is positioned on a top surface of said bitumen compound layer or said fiber reinforcement; 60-100 wt. % of said primary hydrocarbon compound is bitumen; said resin material includes one or more of C4 resins, C5 resins, and/or C6 resins.

17. The self-adhering reinforced bitumen roofing membrane as defined in claim 16, wherein 0.1-20 wt. % of said bitumen compound layer includes isotactic polypropylene (IPP).

18. The self-adhering reinforced bitumen roofing membrane as defined in claim 16, wherein 0.1-66 wt. % of said bitumen compound layer includes filler.

19. The self-adhering reinforced bitumen roofing membrane as defined in claim 16, wherein said bitumen compound layer comprises by weight percent:

| | |
|---|---|
| Primary hydrocarbon compound | 25-90 wt. % |
| APP | 1-30 wt. % |
| Resin Material | 1-25 wt. % |
| Filler | 0-66 wt. % |
| IPP | 0-20 wt. % |
| Secondary Polymer | 0-20 wt. % |
| Hydrocarbon Process Oil | 0-20 wt. % |
| Antioxidant | 0-15 wt. % |
| UV Stabilizer | 0-15 wt. % |
| Cross-Linker | 0-15 wt. % |
| Biocide | 0-10 wt. % |
| Coloring Agent | 0-10 wt. % |
| Metal Flakes | 0-15 wt. % |
| Adhesion Enhancer | 0-10 wt. % |
| Fire Retardant | 0-20 wt. % |
| Tackifying Agent | 0-15 wt. % |
| Softening Agent | 0-15 wt. % |
| Wax | 0-15 wt. % |
| Acid | 0-15 wt. % |
| Reinforcement Fibers | 0-25 wt. %. |

20. A method for applying a roof membrane to a roof system comprising:
a. providing a first sheet of self-adhering reinforced bitumen roofing membrane; said self-adhering reinforced bitumen roofing membrane includes a bitumen compound layer that includes atactic polypropylene (APP), and a fiber reinforcement layer; and
b. positioning a bottom surface of said first sheet of self-adhering reinforced bitumen roofing membrane on a top surface of a roof substrate of said roof system; and
wherein said bottom surface of said first sheet of self-adhering reinforced bitumen roofing membrane has a tacky surface that adhesively connects said bottom surface of said first sheet of self-adhering reinforced bitumen roofing membrane to said top surface of said roof substrate of said roof system when said first sheet of self-adhering reinforced bitumen roofing membrane is pressed against said top surface of said roof substrate of said roof system.

21. The method as defined in claim 20, wherein said first sheet of self-adhering reinforced bitumen roofing membrane is pressed against said top surface of said roof substrate of said roof system by one or more processes selected from i) walking on a top surface of said first sheet of self-adhering reinforced bitumen roofing membrane while said first sheet of self-adhering reinforced bitumen roofing membrane is position said top surface of said roof substrate of said roof system, ii) rolling a roller said top surface of said first sheet of self-adhering reinforced bitumen roofing membrane while said first sheet of self-adhering reinforced bitumen roofing membrane is position said top surface of said roof substrate of said roof system, and/or iii) applying a weighted structures on a top surface of said first sheet of self-adhering reinforced bitumen roofing membrane while said first sheet of self-adhering reinforced bitumen roofing membrane is position said top surface of said roof substrate of said roof system.

22. The method as defined in claim 20, wherein said first sheet of self-adhering reinforced bitumen roofing membrane includes a release liner on said bottom surface of said first sheet of self-adhering reinforced bitumen roofing membrane, and further including the step of removing said release liner on said bottom surface of said first sheet of self-adhering reinforced bitumen roofing membrane prior to said step of positioning a bottom surface of said first sheet of self-adhering reinforced bitumen roofing membrane on a top surface of a roof substrate of said roof system.

23. The method as defined in claim 20, wherein said first sheet of self-adhering reinforced bitumen roofing membrane includes a release film on a top surface of said first sheet of self-adhering reinforced bitumen roofing membrane, and further including the step of removing said release film on said top surface of said first sheet of self-adhering reinforced bitumen roofing membrane after said step of positioning a bottom surface of said first sheet of self-adhering reinforced bitumen roofing membrane on a top surface of a roof substrate of said roof system.

24. The method as defined in claim 20, further including the steps of:
providing a second sheet of self-adhering reinforced bitumen roofing membrane; said first and second sheets of self-adhering reinforced bitumen roofing membrane formed of the same materials;
positioning said second sheet of self-adhering reinforced bitumen roofing membrane next so said first sheet of self-adhering reinforced bitumen roofing membrane such that a portion of a bottom surface of said second sheet of self-adhering reinforced bitumen roofing membrane overlaps a top surface of said first sheet of self-adhering reinforced bitumen roofing membrane and a tacky surface of said bottom surface of said second sheet of self-adhering reinforced bitumen roofing membrane adhesively connects to said top surface of said first sheet of self-adhering reinforced bitumen roofing membrane in said overlapped regions.

25. The method a defined in claim 20, wherein 25-90 wt. % of said bitumen compound layer of said first sheet of self-adhering reinforced bitumen roofing membrane includes primary hydrocarbon compound; 1-30 wt. % of said bitumen compound layer of said first sheet of self-adhering reinforced bitumen roofing membrane includes said APP; 1-25 wt. % of said bitumen compound layer of said first sheet of self-adhering reinforced bitumen roofing membrane includes resin material; 0.1-20 wt. % of said bitumen compound layer of said first sheet of self-adhering reinforced bitumen roofing membrane includes IPP, and e) 0-66 wt. % of said bitumen compound layer of said first sheet of self-adhering reinforced bitumen roofing membrane includes filler; said bitumen compound layer constitutes 30-99 wt. % of said first sheet of self-adhering reinforced bitumen roofing membrane; said fiber reinforcement constitutes 1-70 wt. % of said first sheet of self-adhering reinforced bitumen roofing membrane; a release liner constitutes 0-5 wt. % of said first sheet of self-adhering reinforced bitumen roofing membrane and which release liner is positioned on a bottom surface of said bitumen compound layer or said fiber reinforcement; and a release film constitutes 0-5 wt. % of said first sheet of self-adhering reinforced bitumen roofing membrane and which release film is positioned on a top surface of said bitumen compound layer or said fiber reinforcement; 60-100 wt. % of said primary hydrocarbon compound is bitumen; said resin material includes one or more of C4 resins, C5 resins, and/or C6 resins.
